(19) United States
(12) Patent Application Publication
(10) Pub. No.: US 2026/0049007 A1
(43) Pub. Date: Feb. 19, 2026

(54) Grinding Wastewater Pretreatment Method

(71) Applicant: Dongguan SanRenXing Environmental Technology Co., Ltd., Dongguan City (CN)

(72) Inventors: Weili Jiao, Dongguan City (CN); Jincang Li, Dongguan City (CN)

(21) Appl. No.: 19/282,038

(22) Filed: Jul. 28, 2025

(30) Foreign Application Priority Data
Aug. 16, 2024 (CN) 2024111297424

(51) Int. Cl. C02F 1/44; C02F 1/52; C02F 1/66; C02F 103/12

(52) U.S. Cl. CPC C02F 1/442; C02F 1/5245; C02F 1/66; C02F 2103/12; C02F 2303/06; C02F 2305/14

(57) ABSTRACT

A grinding wastewater pretreatment method has the following steps: S1, taking grinding wastewater and adjusting the pH to 7 using sodium hydroxide or sulfuric acid; S2, adding a demulsifier to the grinding wastewater, stirring, filtering, and collecting a filtrate; S3, adding magnetic nanoscale ferroferric oxide particles and an adsorbent to the filtrate, stirring, allowing to settle, and collecting an upper solution; S4, adding aluminum sulfate and cationic polyacrylamide for sludge dewatering to the upper solution, stirring, and allowing to settle; and S5, passing a filtered liquid through a cotton filtration layer and a ceramic nanofiltration membrane layer in sequence, resulting in pretreated grinding wastewater. The pretreatment method provided by the invention can efficiently remove suspended solids in grinding wastewater.

### BACKGROUND OF THE INVENTION

### 1. Technical Field

The invention relates to the field of wastewater treatment, in particular to a grinding wastewater pretreatment method.

### 2. Description of Related Art

Grinding wastewater in the new display device supply chain mainly originates from the production of electronic glass components like tablet displays and computer screens. The grinding wastewater contains a large amount of nanoscale particles, metal oxides, and organic substances. Although the overall pollutant concentration is relatively low, its poor biodegradability would significantly reduce the treatment efficiency of wastewater treatment plants if discharged directly without specialized pretreatment.

Currently, the treatment of grinding wastewater typically involves integrating targeted processes into physical sedimentation-filtration stages to remove specialized suspended solids, such as physical sedimentation, chemical coagulation, air flotation, and coagulation methods. However, the suspended solids in the grinding wastewater in the new display device supply chain predominantly include nanoscale particles, while the conventional treatment processes are mainly designed for micrometer-sized particles, making it difficult to remove smaller nanoscale particles. Membrane filtration is an effective method for removing nanoscale suspended particles. However, due to the large volume of grinding wastewater and the high content of nanoscale particles, membrane clogging often occurs during filtration, necessitating frequent backwashing to restore the normal filtration function of the membrane, which may increase routine operational maintenance costs. Thus, there is still room for improvement.

### BRIEF SUMMARY OF THE INVENTION

To improve the efficiency of removing nanoscale solid suspended particles during the pretreatment stage of grinding wastewater, the present application proposes a grinding wastewater pretreatment method.

In a first aspect, the application provides a grinding wastewater pretreatment method, utilizing the following technical scheme:
S1, taking grinding wastewater and adjusting the pH to 7 using sodium hydroxide and sulfuric acid;
S2, adding a demulsifier to the grinding wastewater, stirring, filtering, and collecting a filtrate, a filtration layer used during filtration being prepared from a mixture of ceramic powder, activated carbon, and chitosan;
S3, adding magnetic nanoscale ferroferric oxide particles and an adsorbent to the filtrate, stirring, allowing to settle, and collecting an upper solution, the adsorbent being a mixture of activated carbon, diatomaceous earth, and magnesium oxide;
S4, adding an aluminum salt flocculant and cationic polyacrylamide for sludge dewatering to the upper solution, stirring, and allowing to settle to obtain a filtered liquid; and
S5, passing the filtered liquid through a cotton filtration layer and a ceramic nanofiltration membrane layer in sequence, resulting in pretreated grinding wastewater, the cotton filtration layer being prepared from a mixture of long-staple cotton, diatomaceous earth, and silicate.

By adopting the above technical scheme, a multi-stage combined sedimentation process is utilized based on traditional coagulation technology, along with the application of the specific aluminum salt flocculant and cationic polyacrylamide for sludge dewatering, to improve the efficiency of removing suspended solids in grinding wastewater.

First, the pH of the grinding wastewater is adjusted to 7 to avoid acidity or alkalinity that may affect subsequent sedimentation. The demulsifier acts to break down organic materials with emulsified characteristics and colloidal structures in the grinding wastewater, making it easier for suspended solid particles to achieve gravitational sedimentation. Through the filtration process, larger solid particles are removed. The ceramic powder provides a stable support structure and adsorption effect, the activated carbon offers efficient adsorption capabilities, and the chitosan enhances the overall adsorption and filtration effect, resulting in the filtration layer with high removal efficiency for wastewater containing nanoscale solid particles, effectively reducing the concentration of suspended solids and turbidity in the wastewater.

With stirring, the magnetic nanoscale ferroferric oxide particles and the adsorbent collide with nanosilica particles in the grinding wastewater, forming larger polymers. Some of these larger polymers settle under the influence of gravity. Here, the activated carbon, the diatomaceous earth, and the magnesium oxide each play unique roles in the mixed adsorbent, creating a synergistic effect. The activated carbon provides strong adsorption capacity, the diatomaceous earth enhances physical retention, and the magnesium oxide promotes the removal of nanoscale solids through catalytic action. Together, the three components enable the adsorbent to act over a longer period, improving the efficiency of nanoscale particle removal.

The aluminum salt flocculant and the cationic polyacrylamide for sludge dewatering are added to the upper solution. The high-molecular weight cationic polyacrylamide for sludge dewatering exhibits superior sedimentation and flocculation effects. During the synergistic sedimentation process between the cationic polyacrylamide for sludge dewatering and the aluminum salt flocculant, the amino groups coordinate with aluminum ions to form complexes, which combine with suspended polymers in the upper solution to create larger flocculent aggregates, further facilitating the gravitational sedimentation of suspended polymers in the upper solution. Additionally, the reaction process where the aluminum salt flocculant and the cationic polyacrylamide for sludge dewatering form complexes accelerates the formation of flocs, increasing the flocculation and sedimentation rate and addressing the slow flocculation issue of the high-molecular weight cationic polyacrylamide for sludge dewatering during the flocculation process.

Finally, the filtered liquid passes sequentially through the cotton filtration layer and the ceramic nanofiltration membrane layer to further remove smaller nanoscale solids. The cotton filtration layer combines the fiber structure of the long-staple cotton, the adsorptive properties of the diatomaceous earth, and the stability of the silicate, forming an efficient filtration barrier that can more effectively intercept and remove smaller nanoscale solid particles from the wastewater, thereby enhancing the overall removal efficiency.

Optionally, in S2, a weight ratio of the ceramic powder, the activated carbon, and the chitosan is (5-6):(2-3): 3.

By adopting the above technical scheme, a tightly structured filtration layer is formed, effectively removing larger solid particles and further purifying the grinding wastewater, which also facilitates the next step in the treatment of the grinding wastewater.

Optionally, in S3, a weight ratio of the activated carbon, the diatomaceous earth, and the magnesium oxide is (5-8):(3-4): 0.5.

By adopting the above technical scheme, the dosages of the activated carbon, the diatomaceous earth, and the magnesium oxide are optimized to enhance the adsorption efficiency of the adsorbent, further reducing nanoscale solid particles in the wastewater.

Optionally, a weight ratio of the long-staple cotton, the diatomaceous earth, and the silicate is (5-8):(4-7): 3.

By adopting the above technical scheme, the dosages of the long-staple cotton, the diatomaceous earth, and the silicate are optimized, resulting in a denser structure of the cotton filtration layer with excellent filtration and absorption effects, effectively intercepting nanoscale particles with smaller average diameters and improving the efficiency of removing nanoscale solid particles.

Optionally, a mass concentration of the magnetic nanoscale ferroferric oxide particles in the filtrate is 1-2 g/L, and a mass concentration of the adsorbent in the filtrate is 30-50 g/L.

By adopting the above technical scheme, agglomeration and sedimentation of the grinding wastewater with the magnetic nanoscale ferroferric oxide particles at a specific mass ratio can maximize the sedimentation of suspended solids in the grinding wastewater. Additionally, this approach minimizes the risk of adding excessive magnetic nanoscale ferroferric oxide particles, thus reducing the pressure on the filtration membrane in subsequent processes.

Optionally, mass concentrations of the aluminum salt flocculant and the cationic polyacrylamide for sludge dewatering in the upper solution are 0.5-1 g/L and 1-2 g/L respectively.

By adopting the above technical scheme, the flocculant and the cationic polyacrylamide for sludge dewatering are added at specific ratios based on the concentration of suspended solids in the upper solution, enhancing the flocculation and sedimentation effects with minimal dosage. This approach prevents the excessive addition of additives, which may cause additional pollution to water.

Optionally, the aluminum salt flocculant consists of aluminum chloride and aluminum sulfate in a weight ratio of 1:(2-3).

By adopting the above technical scheme, ferrous sulfate and ferric chloride are blended at the aforementioned specific ratios to prepare the demulsifier to disrupt the stable double-layer structure and emulsion system. This effectively breaks down organic materials with emulsified characteristics and colloidal structures in the grinding wastewater, making it easier for suspended solid particles to achieve gravitational sedimentation. Additionally, it enhances the aggregation efficiency of the magnetic nanoscale ferroferric oxide particles with suspended solids in the grinding wastewater, further improving sedimentation efficiency.

Optionally, the demulsifier consists of ferrous sulfate and ferric chloride in a weight ratio of (4-5):1.

By adopting the above technical scheme, aluminum chloride and aluminum sulfate are blended at the specific ratios to prepare the flocculant, which can neutralize the charges on the surfaces of suspended solids in the grinding wastewater, reducing the electrostatic repulsion between suspended particles. This facilitates the formation of flocs with the suspended solids, achieving better gravitational sedimentation effects. The synergy of these two factors further enhances the efficiency of flocculation and sedimentation.

Optionally, in S5, a thickness ratio of the cotton filtration layer to the ceramic nanofiltration membrane layer is (30-50): 3.

By adopting the above technical scheme, the thicknesses of the cotton filtration layer and the ceramic nanofiltration membrane layer are optimized, further enhancing the interception of smaller solid particles. This improves the purity of the final product and reduces its turbidity.

Optionally, a stirring speed in S3 is 200-300 r/min, with a stirring duration of 10-15 minutes.

By adopting the above technical scheme, a faster stirring speed and shorter stirring duration in S3 enable the magnetic nanoscale ferroferric oxide particles to fully contact the solid suspended particles in the grinding wastewater, resulting in the formation of a large number of agglomerates within a short period.

Optionally, a stirring speed in S4 is 50-100 r/min, with a stirring duration of 20-30 minutes.

By adopting the above technical scheme, a slower stirring speed and longer stirring duration in S4 facilitate sufficient contact between the flocs and the agglomerates formed in S3, enhancing the sedimentation efficiency of the agglomerates. Additionally, the low stirring speed minimizes the risk of damaging the floc structure, which may negatively impact sedimentation efficiency.

To sum up, the application has the following beneficial effects.

1. A multi-stage filtration process is utilized based on traditional coagulation technology, along with the application of the specific aluminum salt flocculant and cationic polyacrylamide for sludge dewatering, to improve the efficiency of removing suspended solids in grinding wastewater. First, the pH of the grinding wastewater is adjusted to 7. With stirring, the demulsifier is used to improve the filtration efficiency, allowing the removal of most larger nanoparticles through a specific filtration layer. Then, the magnetic nanoscale ferroferric oxide particles and the adsorbent collide with the nanosilica particles in the grinding wastewater to form larger polymers, which subsequently settle under gravitational forces. The aluminum salt flocculant and the cationic polyacrylamide for sludge dewatering are added to the upper solution to work synergistically in flocculation, further facilitating the gravitational sedimentation of suspended polymers in the upper solution. Additionally, the reaction process where the aluminum salt flocculant and the cationic polyacrylamide for sludge dewatering form complexes accelerates the formation of flocs, increasing the flocculation and sedimentation rate and addressing the slow flocculation issue of the high-molecular weight cationic polyacrylamide for sludge dewatering during the flocculation process. Finally, after passing through the specific cotton filtration layer and ceramic filtration layer, further removal of smaller nanoparticles is achieved.

### DETAILED DESCRIPTION OF THE INVENTION

The application will be further explained with specific embodiments.

The following preparation examples, embodiments, and comparative examples utilize commercially available raw materials, specifically as follows:
cationic polyacrylamide for sludge dewatering was purchased from Shanghai Jiejing Chemical Co., Ltd., with a molecular weight of 12 million;
the CAS number for cationic polyacrylamide is 25085-02-3, with a molecular weight of 167.14;
the CAS number for magnetic nanoscale ferroferric oxide particles is 1317-61-9;
the CAS number for nanosilica is 60676-86-0;
the length of long-staple cotton is 1-2 mm, with a fineness of 7000-8000 meters/gram; and
the ceramic filtration membrane was purchased from Zibo Yuding New Material Technology Co., Ltd., with a pore size specification of 0.1 μm.

### Preparation Example 1

An artificial grinding wastewater preparation method comprises:
taking 1 L of ultrapure water, adding 80 g of nanosilica (with a particle size of 1-500 nm), 4.0 g of sodium acetate, and 3.0 g of sodium bicarbonate, and stirring at a speed of 50 r/min for 10 minutes to obtain artificial grinding wastewater.

### Embodiment 1

A grinding wastewater pretreatment method comprises the following steps:
S1, taking 1 L of grinding wastewater and adjusting the pH of the grinding wastewater to 7 using 0.1 mol/L sodium hydroxide;
S2, adding 0.4 g of ferrous sulfate and 0.1 g of ferric chloride to the grinding wastewater, stirring for 10 minutes, and filtering to obtain a filtrate, a filtration layer used during filtration being prepared by mixing ceramic powder, activated carbon, and chitosan in a weight ratio of 5:2:3, with a thickness of 10 cm, the average particle size of the ceramic powder being 20-30 μm, and the average particle size of the activated carbon being 10-20 μm; S3, adding 69 mL of water to the filtrate to bring the total volume to 1 L, then adding 1 g of magnetic nanoscale ferroferric oxide particles and 30 g of adsorbent, the adsorbent being prepared by mixing activated carbon, diatomaceous earth, and magnesium oxide in a weight ratio of 5:3:0.5, with the average particle size of the diatomaceous earth being 15-30 μm and that of the activated carbon being 10-20 μm, stirring at 200 r/min for 10 minutes, allowing to settle for 30 minutes, and collecting 500 mL of an upper solution;
S4, adding 0.083 g of aluminum chloride, 0.164 g of aluminum sulfate, and 0.5 g of cationic polyacrylamide for sludge dewatering to the upper solution, stirring at 50 r/min for 20 minutes, and allowing to settle for 30 minutes to obtain pretreated grinding wastewater; and
S5, passing a filtered liquid through a cotton filtration layer and a ceramic nanofiltration membrane layer in sequence, resulting in pretreated grinding wastewater, the cotton filtration layer being prepared by mixing long-staple cotton, diatomaceous earth, and silicate in a weight ratio of 5:4:3, with a thickness of 3 cm, and the thickness of the ceramic nanofiltration membrane layer being 0.3 cm.

In this embodiment, the grinding wastewater is prepared according to Preparation example 1.

### Embodiment 2

A grinding wastewater pretreatment method comprises the following steps:
S1, taking 1 L of grinding wastewater and adjusting the pH of the grinding wastewater to 7 using 0.1 mol/L sodium hydroxide;
S2, adding 0.5 g of ferrous sulfate and 0.1 g of ferric chloride to the grinding wastewater, stirring for 10 minutes, and filtering to obtain a filtrate, a filtration layer used during filtration being prepared by mixing ceramic powder, activated carbon, and chitosan in a weight ratio of 5.5:2.5:3, with a thickness of 10 cm, the average particle size of the ceramic powder being 20-30 μm, and the average particle size of the activated carbon being 10-20 μm;
S3, adding 71 mL of water to the filtrate to bring the total volume to 1 L, then adding 2 g of magnetic nanoscale ferroferric oxide particles and 40 g of adsorbent, the adsorbent being prepared by mixing activated carbon, diatomaceous earth, and magnesium oxide in a weight ratio of 6.5:3.5:0.5, with the average particle size of the diatomaceous earth being 15-30 μm and that of the activated carbon being 10-20 μm, stirring at 300 r/min for 15 minutes, allowing to settle for 30 minutes, and collecting 500 mL of an upper solution;
S4, adding 0.16 g of aluminum chloride, 0.24 g of aluminum sulfate, and 0.75 g of cationic polyacrylamide for sludge dewatering to the upper solution, stirring at 100 r/min for 30 minutes, and allowing to settle for 30 minutes to obtain pretreated grinding wastewater; and
S5, passing a filtered liquid through a cotton filtration layer and a ceramic nanofiltration membrane layer in sequence, resulting in pretreated grinding wastewater, the cotton filtration layer being prepared by mixing long-staple cotton, diatomaceous earth, and silicate in a weight ratio of 6.5:5:3, with a thickness of 3 cm, and the thickness of the ceramic nanofiltration membrane layer being 0.3 cm.

In this embodiment, the grinding wastewater is prepared according to Preparation example 1.

### Embodiment 3

A grinding wastewater pretreatment method comprises the following steps:
S1, taking 1 L of grinding wastewater and adjusting the pH of the grinding wastewater to 7 using 0.1 mol/L sodium hydroxide;
S2, adding 0.45 g of ferrous sulfate and 0.1 g of ferric chloride to the grinding wastewater, stirring for 10 minutes, and filtering to obtain a filtrate, a filtration layer used during filtration being prepared by mixing ceramic powder, activated carbon, and chitosan in a weight ratio of 6:3:3, with a thickness of 10 cm, the average particle size of the ceramic powder being 20-30 μm, and the average particle size of the activated carbon being 10-20 μm; S3, adding 74 mL of water to the filtrate to bring the total volume to 1 L, then adding 1.5 g of magnetic nanoscale ferroferric oxide particles and 50 g of adsorbent, the adsorbent being prepared by mixing activated carbon, diatomaceous earth, and magnesium oxide in a weight ratio of 8:4:0.5, with the average particle size of the diatomaceous earth being 15-30 μm and that of the activated carbon being 10-20 μm, stirring at 250 r/min for 12.5 minutes, allowing to settle for 30 minutes, and collecting 500 mL of an upper solution;
S4, adding 0.125 g of aluminum chloride, 0.375 g of aluminum sulfate, and 1 g of cationic polyacrylamide for sludge dewatering to the upper solution, stirring at 75 r/min for 25 minutes, and allowing to settle for 30 minutes to obtain pretreated grinding wastewater; and S5, passing a filtered liquid through a cotton filtration layer and a ceramic nanofiltration membrane layer in sequence, resulting in pretreated grinding wastewater, the cotton filtration layer being prepared by mixing long-staple cotton, diatomaceous earth, and silicate in a weight ratio of 8:7:3, with a thickness of 3 cm, and the thickness of the ceramic nanofiltration membrane layer being 0.3 cm.

In this embodiment, the grinding wastewater is prepared according to Preparation example 1.

### Embodiment 4

A grinding wastewater pretreatment method differs from Embodiment 3 in that an equal amount of alum is used to replace aluminum chloride.

### Embodiment 5

A grinding wastewater pretreatment method differs from Embodiment 3 in that an equal amount of alum is used to replace aluminum sulfate.

### Embodiment 6

A grinding wastewater pretreatment method differs from Embodiment 3 in that in S2, a weight ratio of the ceramic powder, the activated carbon, and the chitosan is 3:2:3.

### Embodiment 7

A grinding wastewater pretreatment method differs from Embodiment 3 in that in S3, a weight ratio of the activated carbon, the diatomaceous earth, and the magnesium oxide is 3:3:0.5.

### Embodiment 8

A grinding wastewater pretreatment method differs from Embodiment 3 in that the demulsifier consists of ferrous sulfate and ferric chloride in a weight ratio of 3:1.

### Embodiment 9

A grinding wastewater pretreatment method differs from Embodiment 3 in that in S5, a thickness ratio of the cotton filtration layer to the ceramic nanofiltration membrane layer is 25:3.

### Comparative Example 1

A grinding wastewater pretreatment method differs from Embodiment 3 in that S2 is omitted.

### Comparative Example 2

A grinding wastewater pretreatment method differs from Embodiment 3 in that the filtration layer used in S2 is a standard nanofiltration layer, which consists of a polytetrafluoroethylene membrane with a filtration precision of 0.1 μm.

### Comparative Example 3

A grinding wastewater pretreatment method differs from Embodiment 3 in that in S2, talc powder is used instead of ceramic powder.

### Comparative Example 4

A grinding wastewater pretreatment method differs from Embodiment 3 in that in S2, talc powder is used instead of activated carbon.

### Comparative Example 5

A grinding wastewater pretreatment method differs from Embodiment 3 in that in S2, chitin is used instead of chitosan.

### Comparative Example 6

A grinding wastewater pretreatment method differs from Embodiment 3 in that no demulsifier is added in S2.

### Comparative Example 7

A grinding wastewater pretreatment method differs from Embodiment 3 in that S3 is omitted.

### Comparative Example 8

A grinding wastewater pretreatment method differs from Embodiment 3 in that no magnetic nanoscale ferroferric oxide particle is added in S3.

### Comparative Example 9

A grinding wastewater pretreatment method differs from Embodiment 3 in that no adsorbent is added in S3.

### Comparative Example 10

A grinding wastewater pretreatment method differs from Embodiment 3 in that in S3, talc powder is used instead of activated carbon.

### Comparative Example 11

A grinding wastewater pretreatment method differs from Embodiment 3 in that in S3, perlite is used instead of diatomaceous earth.

### Comparative Example 12

A grinding wastewater pretreatment method differs from Embodiment 3 in that in S3, calcium citrate is used instead of magnesium oxide.

### Comparative Example 13

A grinding wastewater pretreatment method differs from Embodiment 3 in that S4 is omitted.

### Comparative Example 14

A grinding wastewater pretreatment method differs from Embodiment 3 in that no aluminum salt flocculant is added.

### Comparative Example 15

A grinding wastewater pretreatment method differs from Embodiment 3 in that no cationic polyacrylamide for sludge dewatering is added.

### Comparative Example 16

A grinding wastewater pretreatment method differs from Embodiment 3 in that S5 is omitted.

### Comparative Example 17

A grinding wastewater pretreatment method differs from Embodiment 3 in that S5 involves filtering through only the cotton filtration layer.

### Comparative Example 18

A grinding wastewater pretreatment method differs from Embodiment 3 in that S5 involves filtering through only the ceramic nanofiltration membrane layer.

### Comparative Example 19

A grinding wastewater pretreatment method differs from Embodiment 3 in that in S5, fine-staple cotton is used instead of long-staple cotton.

The length of long-staple cotton is 1-2 mm, with a fineness of 4500-6000 meters/gram.

### Comparative Example 20

A grinding wastewater pretreatment method differs from Embodiment 3 in that in S5, perlite is used instead of diatomaceous earth.

### Comparative Example 21

A grinding wastewater pretreatment method differs from Embodiment 3 in that in S5, mica is used instead of silicate.

### Experiment 1: Turbidity Detection

According to HJ1075-2019 “Water quality-Determination of turbidity”, the turbidity of the grinding wastewater after pretreatment in the above embodiments and comparative examples was measured, with three measurements taken for each group to calculate the average value.

### Experiment 2: Detection of Suspended Solids

According to GB11901-1989 “Water quality-Determination of suspended substance-Gravimetric method”, the content of suspended solids in the grinding wastewater after pretreatment in the above embodiments and comparative examples was measured, with three measurements taken for each group to calculate the average value.

### Experiment 3: Flocs Sedimentation Time

Based on the pretreatment methods in the above embodiments and comparative examples, the time (in seconds) for the flocs to completely settle in S4 was observed and recorded, with three measurements taken for each group to calculate the average value. The experimental data is shown in Table 1:

TABLE 1
Experimental Data for Embodiments
1-9 and Comparative Examples 1-21.

| Embodiments or | | Content of | |
|---|---|---|---|
| comparative | | suspended solids | Sedimentation |
| examples | Turbidity | (mg/L) | time (S) |
| Embodiment 1 | 0.85 | 0.58 | 284 |
| Embodiment 2 | 0.86 | 0.57 | 283 |
| Embodiment 3 | 0.83 | 0.57 | 280 |
| Embodiment 4 | 2.13 | 1.03 | 392 |
| Embodiment 5 | 2.53 | 1.15 | 412 |
| Embodiment 6 | 1.13 | 0.69 | 309 |
| Embodiment 7 | 1.21 | 0.75 | 317 |
| Embodiment 8 | 1.12 | 0.68 | 293 |
| Embodiment 9 | 0.95 | 0.62 | 285 |
| Comparative | 12.27 | 7.47 | 439 |
| example 1 | | | |
| Comparative | 9.12 | 5.55 | 474 |
| example 2 | | | |
| Comparative | 6.38 | 4.15 | 345 |
| example 3 | | | |
| Comparative | 6.02 | 4.13 | 354 |
| example 4 | | | |
| Comparative | 5.68 | 3.97 | 335 |
| example 5 | | | |
| Comparative | 8.13 | 6.54 | 407 |
| example 6 | | | |
| Comparative | 13.43 | 6.87 | 426 |
| example 7 | | | |
| Comparative | 10.25 | 6.04 | 367 |
| example 8 | | | |
| Comparative | 11.58 | 6.11 | 389 |
| example 9 | | | |
| Comparative | 9.53 | 5.48 | 342 |
| example 10 | | | |
| Comparative | 8.67 | 5.89 | 357 |
| example 11 | | | |
| Comparative | 3.41 | 3.81 | 312 |
| example 12 | | | |
| Comparative | 7.68 | 5.17 | No flocculation |
| example 13 | | | |
| Comparative | 6.54 | 4.56 | 499 |
| example 14 | | | |
| Comparative | 5.89 | 3.89 | 487 |
| example 15 | | | |
| Comparative | 1.95 | 1.59 | 284 |
| example 16 | | | |
| Comparative | 1.23 | 0.98 | 286 |
| example 17 | | | |
| Comparative | 1.75 | 1.28 | 285 |
| example 18 | | | |
| Comparative | 1.49 | 1.18 | 284 |
| example 19 | | | |
| Comparative | 1.41 | 1.23 | 286 |
| example 20 | | | |
| Comparative | 1.32 | 1.26 | 287 |
| example 21 | | | |

Based on the comparison of the data in Table 1 for Embodiment 3 and Comparative examples 1-6, it is evident that the turbidity and content of suspended solids in Comparative examples 1-6 are significantly higher than those in Embodiment 3. In the flocs sedimentation time test, the settling rate for Comparative examples 1-6 is notably lower than that for Embodiment 3. This indicates that the treatment in S2 provides a higher removal efficiency for wastewater containing nanoscale solid particles, effectively reducing the concentration of suspended solids and turbidity while accelerating the flocculation process.

Based on the comparison of the data in Table 1 for Embodiment 3 and Comparative examples 7-12, it is evident that the turbidity and content of suspended solids in Comparative examples 7-12 are significantly higher than those in Embodiment 3. In the flocs sedimentation time test, the settling rate for Comparative examples 7-12 is notably lower than that for Embodiment 3. This indicates that the treatment in S3 provides a higher removal efficiency for wastewater containing nanoscale solid particles, effectively reducing the concentration of suspended solids and turbidity while accelerating the flocculation process.

Based on the comparison of the data in Table 1 for Embodiment 3 and Comparative examples 13-15, it is evident that the turbidity and content of suspended solids in Comparative examples 13-15 are significantly higher than those in Embodiment 3. In the flocs sedimentation time test, the settling rate for Comparative examples 13-15 is notably lower than that for Embodiment 3. This indicates that the treatment in S4 provides a higher removal efficiency for wastewater containing nanoscale solid particles, effectively reducing the concentration of suspended solids and turbidity while accelerating the flocculation process.

Based on the comparison of the data in Table 1 for Embodiment 3 and Comparative examples 16-21, it is evident that the turbidity and content of suspended solids in Comparative examples 16-21 are significantly higher than those in Embodiment 3. This indicates that the treatment in S5 provides a higher removal efficiency for wastewater containing nanoscale solid particles, effectively reducing the concentration of suspended solids and turbidity.

Based on the comparison of the data in Table 1 for Embodiment 3 and Embodiments 4-5.8, it is evident that the turbidity and content of suspended solids in Embodiments 4-5.8 are significantly higher than those in Embodiment 3. In the flocs sedimentation time test, the settling rate for Embodiments 4-5.8 is notably lower than that for Embodiment 3. This indicates that preparing an adsorbent by blending activated carbon, diatomaceous earth, and magnesium oxide at the specific ratios is beneficial for enhancing the aggregation efficiency of magnetic nanoscale ferroferric oxide particles with the suspended solids in grinding wastewater, thereby improving settling performance and reducing the concentration of suspended solids and turbidity in the wastewater.

Based on the comparison of the data in Table 1 for Embodiment 3 and Embodiments 6-7, it is evident that the turbidity and content of suspended solids in Embodiments 6-7 are significantly higher than those in Embodiment 3. In the flocs sedimentation time test, the settling rate for Embodiments 6-7 is notably lower than that for Embodiment 3. This indicates that preparing a filtration layer by blending ceramic powder, activated carbon, and chitosan at the specific ratios is beneficial for enhancing the aggregation efficiency of magnetic nanoscale ferroferric oxide particles with the suspended solids in grinding wastewater, thereby improving settling performance and reducing the concentration of suspended solids and turbidity in the wastewater.

Based on the comparison of the data in Table 1 for Embodiment 3 and Embodiment 9, it is evident that the turbidity and content of suspended solids in Embodiment 9 are significantly higher than those in Embodiment 3. This indicates that optimizing the thickness ratio of the cotton filtration layer to the ceramic nanofiltration membrane layer can effectively reduce the concentration of suspended solids and turbidity in the wastewater.

This specific embodiment is merely an explanation of the application and should not be considered a limitation. Those skilled in the art may make non-creative modifications to the embodiment as needed after reading this specification, which are protected by the patent law as long as they are within the scope of the claims of the application.

What is claimed is:

1. A grinding wastewater pretreatment method, comprising the following steps:
S1, taking grinding wastewater and adjusting the pH to 7 using sodium hydroxide or sulfuric acid;
S2, adding a demulsifier to the grinding wastewater, stirring, filtering, and collecting a filtrate, a filtration layer used during filtration being prepared from a mixture of ceramic powder, activated carbon, and chitosan;
S3, adding magnetic nanoscale ferroferric oxide particles and an adsorbent to the filtrate, stirring, allowing to settle, and collecting an upper solution, the adsorbent being a mixture of activated carbon, diatomaceous earth, and magnesium oxide;
S4, adding an aluminum salt flocculant and cationic polyacrylamide for sludge dewatering to the upper solution, stirring, and allowing to settle to obtain a filtered liquid; and
S5, passing the filtered liquid through a cotton filtration layer and a ceramic nanofiltration membrane layer in sequence, resulting in pretreated grinding wastewater, the cotton filtration layer being prepared from a mixture of long-staple cotton, diatomaceous earth, and silicate;
wherein in S2, a weight ratio of the ceramic powder, the activated carbon, and the chitosan is (5-6):(2-3): 3;
in S3, a weight ratio of the activated carbon, the diatomaceous earth, and the magnesium oxide is (5-8):(3-4): 0.5;
a mass concentration of the magnetic nanoscale ferroferric oxide particles in the filtrate is 1-2 g/L, and a mass concentration of the adsorbent in the filtrate is 30-50 g/L;
mass concentrations of the aluminum salt flocculant and the cationic polyacrylamide for sludge dewatering in the upper solution are 0.5-1 g/L and 1-2 g/L respectively;
the aluminum salt flocculant consists of aluminum chloride and aluminum sulfate in a weight ratio of 1:(2-3);
in S5, a thickness ratio of the cotton filtration layer to the ceramic nanofiltration membrane layer is (30-50): 3; and
the demulsifier consists of ferrous sulfate and ferric chloride in a weight ratio of (4-5):1.

2. The grinding wastewater pretreatment method according to claim 1, wherein a stirring speed in S3 is 200-300 r/min, with a stirring duration of 10-15 minutes.

3. The grinding wastewater pretreatment method according to claim 1, wherein a stirring speed in S4 is 100-150 r/min, with a stirring duration of 20-30 minutes.
